(19) United States
(12) Patent Application Publication
(10) Pub. No.: US 2003/0159348 A1
(43) Pub. Date: Aug. 28, 2003

(54) Process and apparatus for pollinating a cannabis crop in a building

(76) Inventor: Jody Don Clark, Kelowna (CA)

Correspondence Address: ANTONY C. EDWARDS, SUITE 800, 1708 DOLPHIN AVENUE, KELOWNA, BC, V1Y 9S4, CA

(21) Appl. No.: 10/374,423

(22) Filed: Feb. 27, 2003

Related U.S. Application Data
(60) Provisional application No. 60/360,014, filed on Feb. 28, 2002.

(51) Int. Cl. A01B 79/02

(52) U.S. Cl. 47/58.1 FV

(57) ABSTRACT

A process for pollinating a crop of female cannabis plant contained in a building having internal ventilation ducting, wherein the process includes the steps of locating an intake for the internal ventilation ducting, providing a dispensable dispersant which includes male cannabis pollen or spores, and administering the dispersant into the intake so as to cause the dispersant to flow downstream into the ducting.

### CROSS REFERENCE TO RELATED APPLICATION

This application claims priority from U.S. Provisional Patent Application No. 60/360,014 filed Feb. 28, 2003 entitled Method and Apparatus for Pollinating a Cannabis Crop in a Building.

### FIELD OF THE INVENTION

This invention relates to a process and apparatus for controlling the cultivation of controlled substances such as cannabis plants within a building, and in particular to a process and apparatus for pollinating a crop of female cannabis plants so as to induce the female plants to go to seed.

### BACKGROUND OF THE INVENTION

To the best of applicant's information, in the year 2000 the police in or about Surrey, British Columbia, Canada conducted search and seizure operations on approximately three hundred fifty illegal marijuana growing operations, and in the first six months of the same year police in or about the cities of Penticton, Kelowna and Vernon, British Columbia Canada conducted search and seizure operations involving seven hundred seventy two illegal marijuana growing operations. Again, to the best of applicant's information, in the first six months of 2001 police in the Penticton, Kelowna and Vernon area located one thousand seventy two illegal marijuana growing operations and estimate that they are only locating between ten and fifteen percent of the actual total number of local illegal marijuana growing operations.

In the province of British Columbia, to the best of applicant's information, private insurance companies paid out between two hundred and three hundred million dollars in claims related to damage caused by illegal marijuana growing operations in the year 2000. Again, to the best of applicant's information, 2001 saw the cultivation and sale of marijuana surpassing forestry as British Columbia's number one industry, at approximately six billion dollars.

Consequently there is evidently a need for a process and apparatus for non-intrusively, preventatively or prophylactically inhibiting the cultivation of a high-value marijuana crop or rendering useless a building which might otherwise be used to house an illegal marijuana growing operation. In many instances such illegal grow operations are located in rental buildings, such as rental residences, where the landlord has no knowledge of the grow operation being conducted and where legislation protecting renters may make inspection by the landlord difficult, inconvenient or useless in catching tenants conducting illegal grow operations. Further, such landlords and their insurance companies will bear the brunt of the damage done to the building for example the damage done by moisture to the wood structure of a building.

### SUMMARY OF THE INVENTION

The present invention includes applying, whether as an aerosol, spray, powder or otherwise, a dispersant which includes the pollen of an illegal grow-operation plant such as hemp and/or male marijuana or cannabis pollen and/or spores into the forced air ventilation, heating or cooling ducting system in a building so as to be carried, air-borne, into the open areas of the building. The pollen and/or spores pollinate or otherwise cause corresponding flowering female plants in the building to go to seed to thereby reduce or destroy their value, for example the values of their buds as a THC resin bearing crop. The application of the pollen or spores may be by any suitable applicator, for example, an elongate injector for urging the pollen or spores from a pollen storage reservoir and out through an injector nozzle when the nozzle is inserted into, for example, an air intake of a fan or air pump moving air into and along the system ducting.

In a further aspect, the present invention may also be characterized as a process for pollinating a crop of female cannabis plant contained in a building having internal ventilation ducting, wherein the process includes the steps of:

a) locating an intake for the internal ventilation ducting,

b) providing a dispensable dispersant which includes male cannabis pollen or spores, and

c) administering the dispersant into the intake so as to cause the dispersant to flow downstream into the ducting.

In a preferred embodiment, the process further includes the step of providing a container for the dispersant and administering the dispersant by dispensing the dispersant from the container.

The step of providing a container may include providing a container having a means for injecting, under force, the dispersant into the intake. The step of providing a dispersible dispersant may include providing the dispersant in a dry granular form. The step of providing a dispensable dispersant may further include providing hemp pollen or spores in addition to the cannabis pollen or spores.

The step of providing a container having a means for injecting under force the dispersant into the intake may include providing a tubular container having a nozzle at one end of the container and a pressurization means towards the other end of the container for urging the dispersant from the container and out through the nozzle. The process may also include inserting the nozzle into the intake and activating the pressurization means.

The pressurization means may be a resilient squeeze bulb and the step of activating the pressurization means may include squeezing the bulb.

As detailed herein, the step of locating an intake may include locating an intake of a forced-air furnace for the building and administering the dispersant into the intake of the furnace, or may include locating an intake comprises locating an intake of a forced-air air conditioner for the building and administering the dispersant into the intake of the air conditioner. The process may also include the step of removing any air filters from the intake before administering the dispersant into the intake.

### BRIEF DESCRIPTION OF THE DRAWINGS

FIG. 1 is, in perspective partially cut away view, a furnace with its filter removed and the pollen applicator inserted according to the present invention for application of marijuana pollen or spores into the air stream of the ventilation system.

FIG. 2 is, in perspective view, the pollen applicator of FIG. 1 according to one embodiment of the present invention.

FIG. 3 is, in perspective view, an end cap for capping the end of the applicator of FIG. 2.

### DETAILED DESCRIPTION OF EMBODIMENTS OF THE INVENTION

Cannabis is the general term applied internationally to the Indian hemp plant, Cannabis sativa, when the plant is used for its pleasure-giving effects. The plant may grow to a height of sixteen feet, but the strains used for drug-producing effects are typically short stemmed and extremely branched. The resinous exudates is the most valued part of the plant because it contains the highest concentration of tetrahydrocannabinol (THC), an active hallucinogenic principle associated with the plant's potency. The term cannabis also encompasses the use of the flowering tops or buds, fruit, seeds, leaves, stems, and bark of the hemp plant even though the potency of these plants parts is considerably less than that of the pure resin itself. The prevention of pollination and the trimming of top leaves to produce dwarfing enhances the content of resin at plant maturity. As used herein, the terms cannabis or marijuana are used interchangeably.

It is applicant's belief that the typical marijuana cultivator running an illegal marijuana grow operation seeks to maximize the yield of the so-called buds of the female marijuana plant which are the parts of the marijuana plant which contain the highest concentration of resin, that is, the highest concentration of THC. This maximizes the value of the crop for sale for its drug-producing or euphoric effects.

The growing of cannabis may take approximately three months from planting until harvest. Typically, it is applicant's belief that cultivators will take great pains to avoid pollination of the mature female plants, for example by culling out the male plants once the female plants reach the flowering stage. Otherwise, the female plants will be pollinated and go to seed thereby potentially drastically reducing the potency and commercial value of the crop.

Applicant has discovered that, for use in buildings have a central ventilation system, such as a central heating or cooling system, spores from the male marijuana plant, for example by the use of hemp and marijuana pollen, may be injected, sprayed, applied or otherwise introduced into the ventilation system periodically with the result being that the spores are circulated through the building by the ventilation system causing a crop of female marijuana plants to go to seed once they flower. Applicant has found that introduction of spores into a ventilation system, depending on the type and size of the ventilation system and the amount of pollen introduced into the ducting of the ventilation system, may require that re-applications only be done possibly as early as every three to six months or perhaps as long as several years, that is, as long as the pollen is viable. The ducting acts as a storage reservoir for the pollen so that each time the ventilation system is activated, the spores, or a percentage of them, are freshly circulated into the open spaces of the building including the rooms in which cultivation is being done.

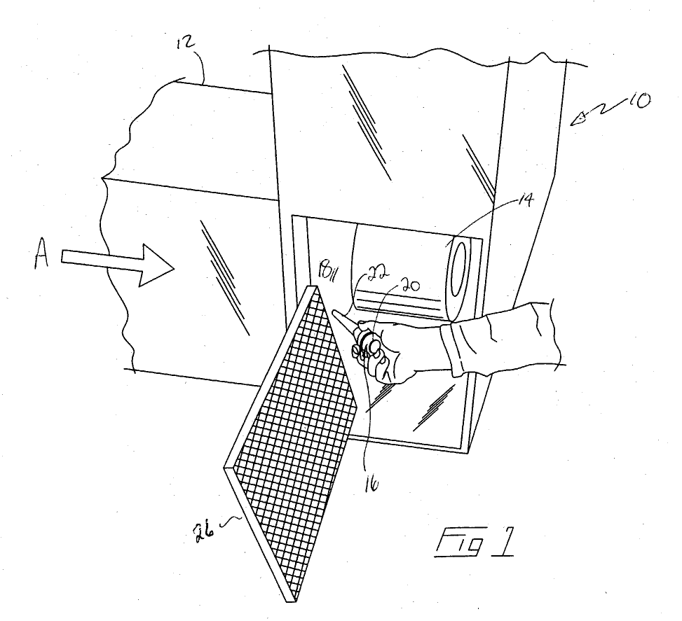

Thus as seen in FIG. 1, a conventional furnace 10 cooperates with ducting 12 so as to move an airflow through the ducting, for example in direction A, upon the urging of a selectively actuable air mover such as, for example, a thermostatically controlled fan 14 mounted within furnace 10.

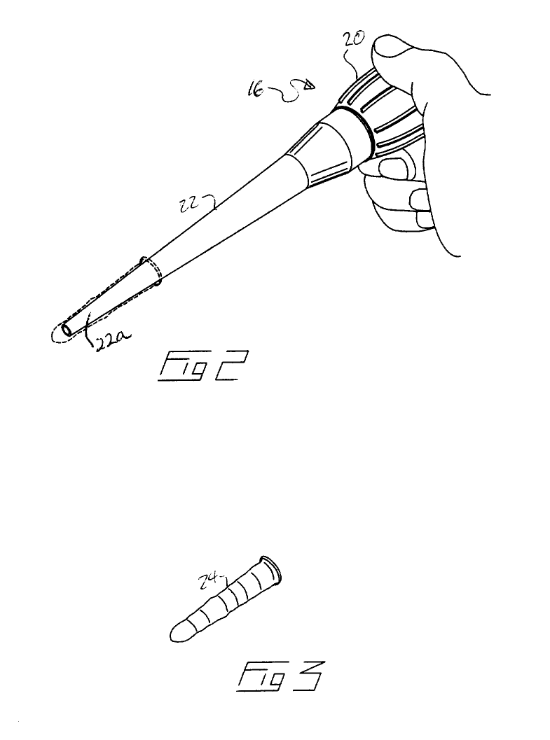

In one embodiment of the present invention, a quantity of spores or spore containing pollen from the male cannabis or marijuana plant, and in one alternative embodiment also from the hemp plant, are contained within an applicator device such as squeeze-bulb applicator 16 although this form of application is not intended to be limiting. As illustrated, applicator 16 may be held so as to point into the fan intake manifold 18 of furnace 10. Applicator 16 is better seen in FIG. 2. Although not intended to be limiting as other forms of pollen or spore applicators may work equally well, applicator 16 may be a conventional squeeze-bulb mounted onto a tube having an opposite end shaped like a nozzle or funnel, such as a so-called “turkey baster”. The squeeze-bulb 20 may be removable by the user from the elongate tube 22 so that a quantity of spores or pollen may be introduced into the bulb for storage, ready for use. With the bulb filled and re-mounted onto the wide open end of the tube, a cap or sleeve 24 may be employed over the narrow funnel end 22a of the tube to prevent unwanted discharge of the spores or pollen until such time as the funnel has been directed into manifold 18. Thus, with the air filter 26 removed from furnace 10, or otherwise any air filtering arrangement disabled or removed from the air passageways of the ducting and furnace, funnel end 22a may be pointed into the air flow path of the ducting, advantageously into the intake area of fan 14, and bulb 20 squeezed by the user so as to eject the pollen or spores stored in the bulb into the air stream during the operation of the fan. The pollen or spores are thereby distributed throughout the ducting feeding the air flow into the building. This circulates a fine concentration of the spores or pollen into the air space of the building containing the female marijuana plant crop.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A process for pollinating a crop of female cannabis plant contained in a building having internal ventilation ducting comprising the steps of:
a) locating an intake for the internal ventilation ducting,
b) providing a dispensable dispersant which includes male cannabis pollen or spores, and
c) administering the dispersant into the intake so as to cause the dispersant to flow downstream into the ducting.

2. The process of claim 1 further comprising the step of providing a container for the dispersant and administering the dispersant by dispensing the dispersant from the container.

3. The process of claim 2 wherein the step of locating an intake comprises locating an intake of a forced-air furnace for the building and administering the dispersant into the intake.

4. The process of claim 2 wherein the step of locating an intake comprises locating an intake of a forced-air air conditioner for the building and administering the dispersant into the intake.

5. The process of claim 2 wherein the step of providing a container comprises providing a container having a means for injecting under force the dispersant into the intake.

6. The process of claim 5 wherein the step of providing a dispersible dispersant comprises providing the dispersant in a dry granular form.

7. The process of claim 6 wherein the step of providing a dispensable dispersant further comprises providing hemp pollen or spores in addition to the cannabis pollen or spores.

8. The process of claim 5 wherein the step of providing a container having a means for injecting under force the dispersant into the intake comprises providing a tubular container having a nozzle at one end of the container and a pressurization means towards the other end of the container for urging the dispersant from the container and out through the nozzle.

9. The process of claim 3 further comprising the step of removing any air filters from the intake before administering the dispersant into the intake.

10. The process of claim 8 further comprising inserting the nozzle into the intake and activating the pressurization means.

11. The process of claim 10 wherein the pressurization means is a resilient squeeze bulb and the step of activating the pressurization means includes squeezing the bulb.
